(19) United States
(12) Patent Application Publication
(10) Pub. No.: US 2015/0235333 A1
(43) Pub. Date: Aug. 20, 2015

(54) RELOCATION, PROPERTY RENTAL, PURCHASE, AND MANAGEMENT FACILITATION

(71) Applicant: Rentler, LLC, Sandy, UT (US)

(72) Inventors: Jason Bangerter, Sandy, UT (US); Dustin Dahl, Portland, OR (US); Cory Hedges, Portland, OR (US); Matthew Kruskamp, Murray, UT (US)

(21) Appl. No.: 14/628,202

(22) Filed: Feb. 20, 2015

Related U.S. Application Data
(60) Provisional application No. 61/942,216, filed on Feb. 20, 2014.
(60) Provisional application No. 61/942,214, filed on Feb. 20, 2014.

(51) Int. Cl. G06Q 50/16; G06Q 30/06

(52) U.S. Cl. CPC G06Q 50/163; G06Q 30/0645; G06Q 40/025

(57) ABSTRACT

An apparatus to facilitate property rental, purchase, and management includes a user profile module, a property profile module, a notification module, a payment transaction module, and a renter evaluation module. The user profile module stores a user profile that includes biographical information, government issued identification, credit background, rental history, rental rating, and home purchasing preferences. The property profile module monitors a vacant rental property. The notification module schedules and sends alerts of one or more expected events to users. The payment transaction module transfers payments between users. The renter evaluation module determines whether a renter is a qualified potential homeowner.

### FIELD

This invention relates to property rentals, purchases, and management, and more particularly relates to a computer system for facilitating property rentals, purchases, management, and relocation.

### BACKGROUND

Online rental listing services allow landlords to advertise their rental properties to a large number of potential renters and renters to peruse a larger selection of properties. But beyond the initial advertising of and search for rental housing, the process of executing a lease agreement, paying/collecting rent, and managing maintenance of rental properties remains mostly inefficient. Renters have to fill out a rental application for each property, and the same credit or criminal background check for the same renter will be conducted for each rental application. Once a lease is signed, the renter typically pays the rent with a check that needs to be deposited by the landlord. Repair and maintenance of rental properties typically require multiple telephone calls and/or e-mails between landlords, tenants, and the third party service provider. For renters, leasing a property typically entails a collection of other tasks such as (1) starting and/or switching various services (e.g., utilities, internet, television, and telephone, renter's insurance, landscaping) and (2) hiring relocation services. For landlords, keeping track of rental properties, lease agreements, rental payments, and coordinating the maintenance of rental properties is often time consuming and expensive when contracted to third parties.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for facilitating property rentals, purchases, and management;

FIG. 2 is a schematic block diagram illustrating one embodiment of an apparatus for facilitating property rentals, purchases, and management;

FIG. 3 is a schematic block diagram illustrating another embodiment of an apparatus for facilitating property rentals, purchases, and management;

FIG. 4 is a schematic flow chart illustrating one embodiment of a method for facilitating property rentals, purchases, and management.

FIG. 5 is a schematic flow chart illustrating another embodiment of a method for facilitating property rentals, purchases, and management.

FIG. 6 is a schematic flow chart illustrating one embodiment of a method for facilitating relocation and property management.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

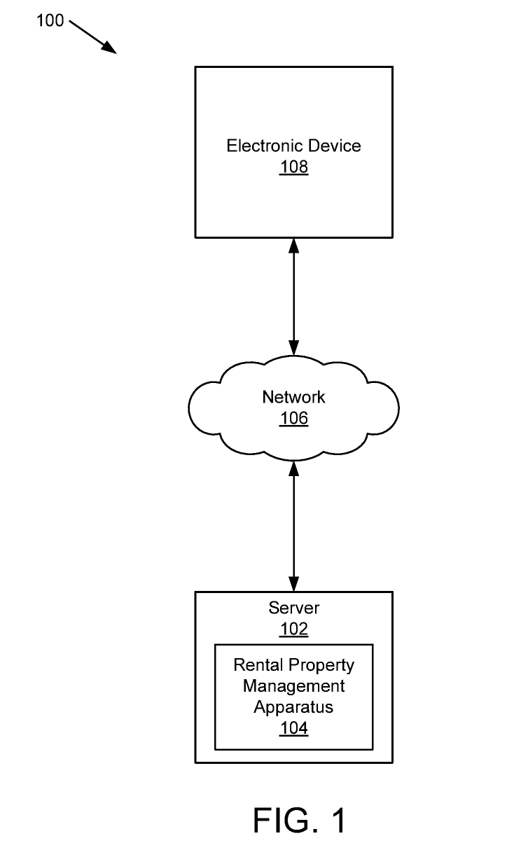

FIG. 1 is a schematic block diagram illustrating one embodiment of a system 100 for facilitating property rentals, purchases, and management. The system 100 includes a server 102, a rental property management apparatus 104, a network 106, and an electronic device 108, which are described below.

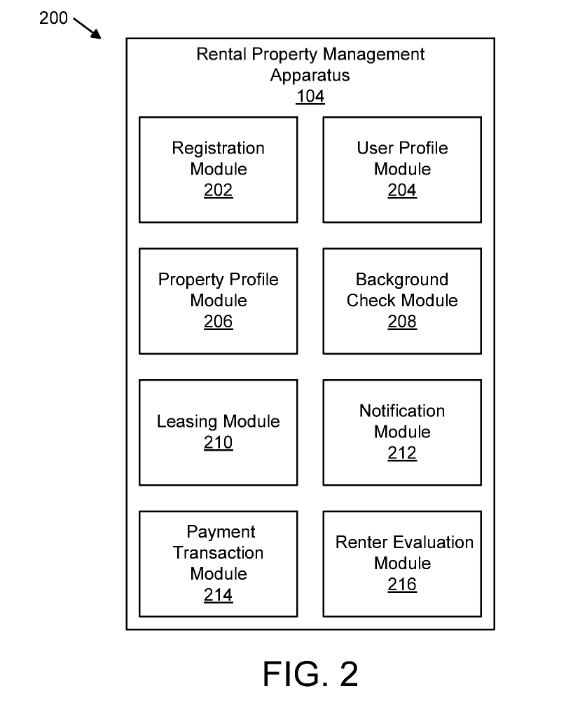

The system 100, in one embodiment, includes a server 102 with a rental property management apparatus 104. The rental property management apparatus 104, in one embodiment, sends and receives user and property information over a network 106 to and from an electronic device 108. The server 102 may be any computer accessible by a computer over a network 106, including but not limited to a database server, a mainframe server, a workstation, a desktop computer, etc. The rental property management apparatus 104 is described in more detail with respect to the apparatus 200 in FIG. 2.

The network 106 may include a local area network (“LAN”), a wide area network (“WAN”), wireless network, cellular network, the Internet, a fiber optic network, or the like. In one embodiment, the network 106 includes multiple networks. For example, the network 106 may include a cellular network along with another network capable Internet connection. In another example, the network 106 includes a wireless network along with a wired network. The network 106 may include switches, routers, servers, cabling and other equipment known to those in the art. The electronic device 108 may be any device capable of sending and receiving user and property information over a network 106. For example, the electronic device 108 may be a laptop or a desktop computer. In another example, the electronic device 108 may be a tablet. Alternatively, the electronic device 108 may be a smartphone.

FIG. 2 is a schematic block diagram illustrating one embodiment of an apparatus 200 for facilitating property rentals, purchases, and management. The apparatus 200 includes one embodiment of a rental property management apparatus 104 with a registration module 202, a user profile module 204, a property profile module 206, a background check module 208, a leasing module 210, a notification module 212, a payment transaction module 214, and a renter evaluation module 216, which are described below.

The registration module 202 creates a user account and profile using information provided by a user through the electronic device 108. The registration module 202, in one embodiment, creates a user account having a username, password, e-mail address, and the first name and last name of the user. A user may be a prospective renter or a landlord. A landlord may be an individual or an organization (e.g., property management company). In one embodiment, a user may also be a third party service provider such as a tradesman (e.g., plumber, electrician), a real estate professional (e.g. realtor), a moving company, a lender, or the like. In another embodiment, a user may also be a representative or employee of a rental listing service.

A user profile is associated with a user account. The user profile module 204 allows a user to view, supplement, update, revise, or delete information from the user profile, which contains a user's biographical information (e.g., first and last name, birthdate), contact information (e.g., e-mail address, phone number), and type (e.g., renter, landlord, third party service provider, administrator). In one embodiment, the user profile also includes government issued identification (e.g., social security number, driver's license number, passport number, taxpayer identification number). In some embodiments, the user profile may be associated with more than one type (e.g., a renter or landlord is also a third party service provider). In certain embodiments, the user profile module 204 stores feedback (e.g., ratings, comments) for a user from one or more other users.

Depending on the user profile type(s), the user profile may contain other information. A renter user profile contains information pertaining to a credit background of the user, a criminal background of the user, an employment background of the user, and a housing history of the user. The credit background of the user includes a credit report from one or more credit reporting agencies (e.g., Experian, TransUnion, Equifax). In one embodiment, the credit background of the user also includes bank account information, credit card information, and tax return data. The bank account and/or credit card information may be used to make rental payments on properties rented by the user. The criminal background of the user includes information regarding whether the user has ever been cited, arrested for, or convicted of a crime. In some embodiments, the criminal background of the user also includes specific details of the arrest and/or conviction. The employment background of the user includes information regarding the user's current occupation, employer, and income. In certain embodiments, the employment background of the user also includes one or more past occupations, employers, or income figures.

The housing history of the user includes one or more properties where the user previously resided. In one embodiment, the housing history of the user includes a rental history of the user. The rental history includes one or more properties previously or currently leased by the user and the length of the lease. The length of the lease could be the written lease term and/or the actual amount of time the user leased a property. In certain embodiments, the rental history of the user also includes, for each property, a rental payment history and a copy of the lease agreement. The rental payment history for a property includes, for each payment period (e.g., month), an amount paid, a payment date, and an indication whether the payment was late. In some embodiments, the housing history of the user also includes one or more properties where the user previously resided without paying rent (e.g., college dormitory, military housing, relative's home, own home). The rental history may also include the reason a user left a rental property (e.g., eviction, ouster, job relocation).

A renter user profile, in one embodiment, also includes a rating of the renter, one or more lease agreements executed by the renter, and the lease termination date for each lease agreement. The renter rating is determined by a combination of the user's credit background, criminal background, employment background, and rental history. Using other components in addition to credit history allows a landlord to better gauge the quality of a prospective tenant. The various components of a renter rating may be weighted to favor certain components and/or more recent events. For example, a renter user's most recent income history may be weighted more heavily than his or her criminal background from a few years ago. The renter rating may be expressed as a letter (e.g., B^{k}), number (e.g., 90 out of 100), or the like (e.g., 3.5 stars, platinum/gold/silver/bronze). In some embodiments, the renter rating may include a directional component that indicates recent movements in the renter rating. For example, the renter rating may include arrows indicating whether the current renter rating was trending up, down, or remained static compared to a past rating for the same renter. In some embodiments, the renter user profile also includes the home purchasing preferences for the renter. The home purchasing preferences include whether the renter is planning to purchase a home (i.e., home buying preference), and if so, when the renter is planning to purchase a home (i.e., home buy date). In some instances, the home buying preferences also include one or more locations the renter would like to buy a home (e.g., city, zip code, school district).

A landlord user profile contains information pertaining to one or more rental properties owned and/or managed by the landlord. The landlord user profile, for each rental property owned and/or managed by the landlord, includes a link to the profile of the property. The property profile is described in more detail with respect to the property profile module 206 below. In one embodiment, the landlord user profile also contains information pertaining to one or more bank accounts for the landlord. The bank account information may be used to facilitate the deposit of rental payments for rental properties owned and/or managed by the landlord. In another embodiment, the landlord user profile includes one or more lease agreements executed by the landlord. In some embodiments, the landlord user profile also includes feedback provided by renters of the rental properties owned and/or managed by the landlord. The feedback can include typewritten comments and/or a rating of the landlord. The rating of the landlord provided by a renter may be expressed as a letter (e.g., B^{k}), number (e.g., 90 out of 100), or the like (e.g., 3.5 stars, platinum/gold/silver/bronze). In another embodiment, the landlord user profile includes an overall rating of the landlord. The overall rating of the landlord is determined by the individual ratings of the landlord provided by renters. In one embodiment, the overall rating is just the average (i.e., mean) of the individual landlord ratings. The overall rating may also be the median of the individual landlord ratings. In some embodiments, the overall rating for the landlord may include a directional component that indicates recent movements in the overall rating. For example, the overall rating may include arrows indicating whether the current overall rating was trending up, down, or remained static compared to a past rating for the same landlord.

A third party service provider profile contains information pertaining to the type of service(s) offered by the third party service provider. In one embodiment, the third party service provide profile includes a listing of the service(s) provided by the third party service provider, one or more professional licenses held by the third party service provider, whether the third party service provider is bonded, rates, service area, hours of operation, and the like. In another embodiment, the third party service provider profile includes information pertaining to one or more bank accounts. The bank account information may be used to facilitate the deposit of payments by landlords or renters. In some embodiments, the third party service provider profile includes feedback provided by renters and/or landlords who received services provided by the third party service provider. The feedback can include typewritten comments and/or a rating of the third party service provider. The rating of the third party service provider provided by a renter or landlord may be expressed as a letter (e.g., B^{k}), number (e.g., 90 out of 100), or the like (e.g., 3.5 stars, platinum/gold/silver/bronze). In another embodiment, the third party service provider user profile includes an overall rating of the third party service provider. The overall rating of the third party service provider is determined, in one embodiment, by the individual ratings of the third party service provider provided by renters and/or landlords. Sometimes, the overall rating is just the average (i.e., mean) of the individual third party service provider ratings. At other times, the overall rating may be the median of the individual third party service provider ratings. In some embodiments, the overall rating for the third party service provider may include a directional component that indicates recent movements in the overall rating. For example, the overall rating may include arrows indicating whether the current overall rating was trending up, down, or remained static compared to a past rating for the same third party service provider. In certain embodiments, the overall rating of the third party service provider is also determined by how the service provider was paid by the renter or landlord. For example, a third party service provider may receive a higher rating from a rental listing service if the payment to the service provider was made through the payment transaction module 214 described further below. In still other embodiments, the overall rating of the third party service provider is also determined by the total number of times he or she has been rated or the frequency of the ratings for the third party service provider.

The property profile module 206 allows a landlord to create, view, supplement, update, revise, or delete information from a rental property profile, which contains a property address (e.g., street address, city, zip code), a property type (e.g., house, apartment, condominium), a property size (e.g., interior square footage and/or total lot size), a number of bedrooms, a number of bathrooms, a rental price, a rental deposit amount, a lease term (i.e., length of the lease), a link to a landlord user profile for the landlord that owns and/or manages the property, and an indicator of whether the property is currently available for rent. In certain embodiments, the property profile also contains one or more other pieces of data about the property, such as a written description of the property, the number of available parking spaces, the school district the property is located within, when the property will be available for rent, the number of stories (e.g., one story, two story, basement), one or more photos of the property, restrictions (e.g., pets, smoking, number of residents), and/or a list of amenities (e.g., cable television, swimming pool, washer/dryer, furniture, alarm system, gated entry, snow removal, landscaping services). The system 100 allows users to search for and view properties by data elements in the property profile. For example, a user can search for and view all ground level apartments in a specific zip code with three bedrooms and two bathrooms between 1,500 and 2,000 square feet. In one embodiment, a user may view all properties regardless of whether a property is currently available for rent. In another embodiment, a user may view only properties that are currently available for rent.

In certain embodiments, the property profile module 206 also interfaces remotely with intelligent parts of a rental property (e.g., thermostat, alarm system, smoke detector, cameras, lighting, sprinklers, appliances, locks) to help landlords monitor the property or facilitate rentals. For example, the property profile module 206 may monitor various systems in a vacant rental property to determine whether certain systems need to shut off (e.g., electrical) or repaired (e.g., smoke detectors). In some embodiments, the property profile module 206 transmits commands from a landlord to remotely control one or more features of a rental property. For example, the property profile module 206 may allow a landlord to remotely unlock a vacant rental property for a prospective tenant by either sending an unlock command to an electronic lock at the rental property or sending the prospective tenant a one-time entry code for opening the lock. In one embodiment, the property profile module 206 may notify a landlord in response to detecting one or more changes in the condition of a rental property. For example, the property profile module 206 may monitor the lighting system or locks at a vacant rental property and notify the landlord if it detects unauthorized entry or use.

The background check module 208 allows a landlord to request and view the credit and/or criminal backgrounds of potential renters by submitting their identities. In one embodiment, the landlord submits the name of the potential renter. In another embodiment, the landlord submits the name of the potential renter and one or more government issued identifications. The background check module 208 sends the information submitted by the landlord and searches one or more databases for (i) one or more credit reports of the renter and/or (ii) one or more criminal records of the renter. These databases may be maintained by third parties (e.g., credit reporting agencies, government sex offender registries, law enforcement). In one embodiment, the background check module 208 provides the landlord with a permanent copy of the search results, including any credit reports or criminal records. In another embodiment, the background module 208 provides the landlord with a link to a temporary copy of the search results.

The leasing module 210 allows a renter to apply to rent one or more properties and renters and landlords to execute lease agreements. The leasing module 210, in one embodiment, allows users to apply to rent a property by providing an online rental application for the renter to fill out and submits the application to landlords. The renter may submit a rental application for multiple properties. In the alternative, the renter may submit a separate rental application each property. In some embodiments, the leasing module 210 populates the rental application for the renter with information from the renter's user profile. The leasing module 210, in another embodiment, allows a renter to apply to rent one or more properties by sending the landlord(s) that owns and/or manages the propert(ies) an invitation through the notification module 212 to view the sender's renter profile. The invitation, in one embodiment, has a link to a limited view of the sender's renter profile. In one instance, the limited renter profile includes the renter's biographical information, employment background, rental history, contract information, and/or renter rating. In another instance, the limited renter profile may also include one or more government issued identifications for the renter that the landlord can use to request and view the renter's credit and criminal backgrounds.

The leasing module 210 also allows renters and landlords to execute lease agreements for a property. In one embodiment, the leasing module 210 records electronic signatures from renters and landlords for lease agreements. In this embodiment, the leasing module 210 stores with a copy of the lease agreement the electronic signature of the renter and landlord, along with a timestamp of when the lease agreement was executed by the renter and landlord. In another embodiment, the leasing module 210 stores scanned copies of physically signed lease agreements uploaded by either renters or landlords. The leasing module 210 saves a copy of the executed lease agreement in the user profiles of the renters and landlords.

The notification module 212 schedules and sends alerts/reminders of one or more expected events to users. Expected events include property leasing related events, such as the execution of a lease, the arrival of a payment due date or lease termination date, or a rental payment. Expected events may also include home purchasing preferences, such as a planned home buying date. Alerts and reminders may take the form of an e-mail, a text message (i.e., MMS or SMS messages), a pre-recorded telephone call, or the like. In one embodiment, the notification module 212 automatically schedules and sends reminders for expected events. For example, the notification module 212 can automatically schedule reminders that a rental payment is due when a lease agreement is executed. Similarly, the notification module 212 can automatically schedule a reminder of a lease termination date for the landlord when a lease agreement is executed. Such a reminder can include a rental history of the renter, the rating of the renter, and other relevant information. The reminder can also include a query asking if the landlord would like to renew the lease, maintain the lease on a month-to-month or other periodic basis, or make the property available for rent on a rental listing service. If the landlord opts to make the property available for rent, the property profile module 206 would update the availability of the property and its availability date.

In another embodiment, the notification module 212 schedules and sends alerts/reminders in response to user input. For example, a renter may see that a property is available for rent in six months and schedule to receive a reminder of the property sometime before that date. A user may dictate the frequency of reminders sent by the notification module 212 and when the reminder should be sent (i.e., how long before the expected event). In some cases, once a renter indicates a home buying preference, the notification module 212 schedules a reminder of the renter's home buying preference to be sent to the renter around the home buy date.

In some embodiments, the notification module 212 directly sends alerts to users in response to expected events. For example, the notification module 212 directly alerts the landlord when a renter has applied to rent a specific property, executed a lease agreement, or made a rental payment. Similarly, the notification module 212 can send an alert to the renter directly when the landlord executes a lease agreement.

The payment transaction module 214 transfers payments between users or users and third parties. For example, the payment transaction module 214 allows a renter to pay a rental application fee, make a rent payment, or pay a third party service provider. The renter can submit his or her credit card or bank account information, as well as the payee information, to the payment transaction module 214, which will debit the bank account or charge the credit card, and then credit a bank account designated by the payee. If desired, the renter can set up recurring automated payments. In some instances, a payment may be routed through an intermediate bank account before it reaches the bank account designated by the payee. For example, a rental listing service with an ACH (i.e., Automated Clearing House) account may deposit rent payments from the renter into its own bank account before transferring the payments into the landlord's bank account. This relieves landlords with one or two properties from needing an ACH account. In one embodiment, after a payment has been sent or received, the payment transaction module 214 will send a payment confirmation alert to the payer and/or payee using the notification module 212. As another example, the payment transaction module 214 transfers a referral fee from a third party service provider (e.g., mortgage lender, realtor) to a rental listing service in response to receiving a referral of one or more renters.

The renter evaluation module 216 determines whether a renter is a qualified potential homeowner. In one embodiment, a qualified potential homeowner is a renter who has expressed a home buying preference indicating that he or she plans to be a homeowner. In another embodiment, a qualified potential homeowner is a renter who meets a mortgage underwriting standard. The mortgage underwriting standard may account for income, debt, credit history, savings, and/or other similar metrics. The renter evaluation module 216, in certain embodiments, determines whether a renter is qualified potential homeowner based upon the home buying preference of the renter. In other embodiments, the renter evaluation module 216 determines whether a renter is qualified potential homeowner based upon the credit background, rental rating, and rental history of the renter.

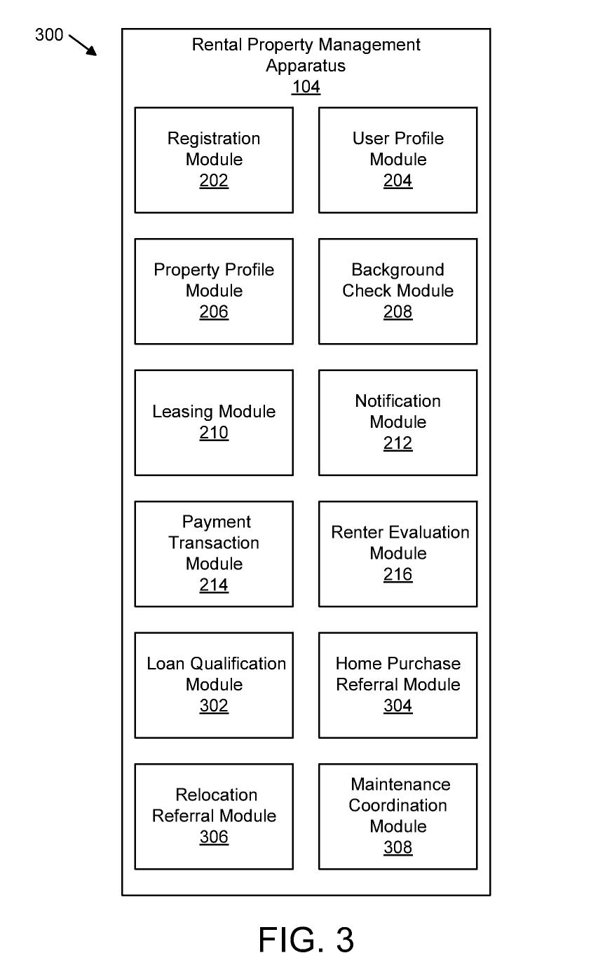

FIG. 3 is a schematic block diagram illustrating another embodiment of an apparatus 300 for facilitating property rentals, purchases, and management. The apparatus 300 includes one embodiment of a rental property management apparatus 104 with a registration module 202, a user profile module 204, a property profile module 206, a background check module 208, a leasing module 210, a notification module 212, a payment transaction module 214, a renter evaluation module 216, a loan qualification module 302, a realtor reference module 304, a relocation referral module 306, and a maintenance coordination module 308, which are described below.

The registration module 202, user profile module 204, property profile module 206, background check module 208, leasing module 210, notification module 212, payment transaction module 214, and renter evaluation module 216 in FIG. 3 are substantially similar to the modules described above with respect to the apparatus 200 in FIG. 2. The loan qualification module 302 pre-qualifies a renter for a mortgage in response to determining that the renter is a qualified potential homeowner. In one embodiment, the loan qualification module 302 pre-qualifies a renter for a mortgage by submitting the user profile of the renter to a mortgage lender. In this embodiment, the loan qualification module 302 uses the user profile of a renter to prepare a loan application for the renter. The renter may then submit the application to one or more lenders through the loan qualification module 302. Conceivably, the loan qualification module 302 can prepare a loan application that does not include the renter's credit background and only the renter's rental history and rating. In another embodiment, the loan qualification module 302 displays links or advertisements to the websites of one or more lenders. In this embodiment, a renter may select a link or advertisement for a lender and submit a loan application on the lender's website.

In certain embodiments, if the renter has indicated a home buying preference and home buy date, the loan qualification module 302 sends an invitation to the renter to pre-qualify for a mortgage before the home buy date. Alternatively, the loan qualification module 302 may allow a user (e.g., lender) to identify renters who have indicated a home buying preference in order to solicit these renters to submit a loan application. In yet another embodiment, the loan qualification module 302 allows a user (e.g., rental listing service) to identify renters who have indicated a preference for purchasing a home in order to market their contact information to lenders. In this embodiment, the loan qualification module 304 allows the user to identify renters by geographic location (e.g., city, zip code, school district), home buy date, renter rating, or the like.

The realtor reference module 304 refers one or more realtors to a renter. In one embodiment, the realtor reference module 304 refers one or more realtors to a renter based upon the home purchasing preferences of the renter. For example, the realtor reference module 304 may refer one or more realtors to a renter based upon the preferred buying location expressed by the renter in his or her home purchasing preferences. In another embodiment, the realtor reference module 304 refers one or more realtors to a renter based upon marketing or referral fees paid by the realtor. For example, the realtor reference module 304 may refer all realtors who have paid a marketing fee to a rental listing service to renters. In another embodiment, the realtor reference module 304 may refer one or more realtors to renters based upon the rating of the realtor. For example, the realtor reference module 304 may only refer realtors who have a rating that meets a certain threshold to renters. The realtor reference module 304 may refer one or more realtors to renters in a variety of ways. The realtor reference module 304 may display the user profiles of realtors and/or advertisements submitted by realtors. Alternatively, the realtor reference module 304 can send alerts directly to renters through the notification module 212.

In some embodiments, the realtor reference module 304 allows a user (e.g. realtor) to identify renters who have indicated a home buying preference in order to solicit these renters as their clients. In yet another embodiment, the realtor reference module 304 allows a user (e.g., rental listing service) to identify renters who have indicated a home buying preference in order to market their contact information to realtors. In this embodiment, the realtor reference module 304 allows the user to identify renters by geographic location (e.g., city, zip code, school district), home buy date, renter rating, or the like.

In one embodiment, the relocation referral module 306 recommends one or more products or services to a renter upon the execution of a lease agreement by the renter. When a renter leases a property, he or she will typically need to purchase or transfer various products or services associated with his or her current residence to the newly leased property. These products and services may include renter's insurance, utility services, internet service, television service, telephone service, landscaping services, etc. In addition, the renter may also need to hire a third party to assist with the move from the renter's current residence to the newly leased property. The relocation referral module 306 assists renters in tracking and managing tasks associated with their impending move by recommending commonly used products and services. The recommendations sent by the relocation referral module 306 may appear in the form of a webpage, an e-mail, a text message, or a video. In one embodiment, the relocation referral module 306 tailors its recommendations based upon the location of the rental property. For example, in recommending cable service providers, the relocation referral module 306 will only recommend cable service providers operating in the geographic region that the rental property is situated within. In another embodiment, the relocation referral module 306 tailors its recommendations based upon the current address of the renter (i.e., where the renter is moving from). For example, the relocation referral module 306 may recommend local banks, supermarkets, and other shops if it determines that the renter is moving from a distant location (e.g., another city, out-of-state, foreign country). In certain embodiments, the relocation referral module 306 recommends one or more products or services to a renter upon a change in the indicator of whether a rental property is available for rent. When a landlord modifies the profile of a rental property to indicate that it is no longer for rent, it is typically an indication that the property has been rented. The relocation referral module 306 may inquire the landlord about whether the property has been rented and when the lease will begin. Then, the relocation referral module 306 assists renters in tracking and managing tasks associated with their impending move by recommending commonly used products and services, as described above.

In one embodiment, the maintenance coordination module 308 displays third party service providers who perform maintenance and repairs on rental properties for landlords and renters. The maintenance coordination module 308 may display these property maintenance and repair service providers in various ways. For example, the list of maintenance and repair service providers may be displayed alphabetically, by distance to the rental property, price, rating, or other metric. In some embodiments, the maintenance coordination module 308 filters the listing of property maintenance and repair service providers based on criteria specified by users (e.g., price, rating, distance, availability). In other embodiments, the maintenance coordination module 308 filters the listing of property maintenance and repair service providers based upon the type of user (e.g., renter, landlord, third party service provider). In certain embodiments, the maintenance coordination module 308 transmits communications between landlords, renters, and third party service providers who perform maintenance and repairs on rental properties. For example, a renter may transmit a maintenance request to a landlord through the maintenance coordination module 308. Similarly, a landlord may contact property maintenance and repair service providers through the maintenance coordination module 308 to inquire about their availability, price, or other qualifications.

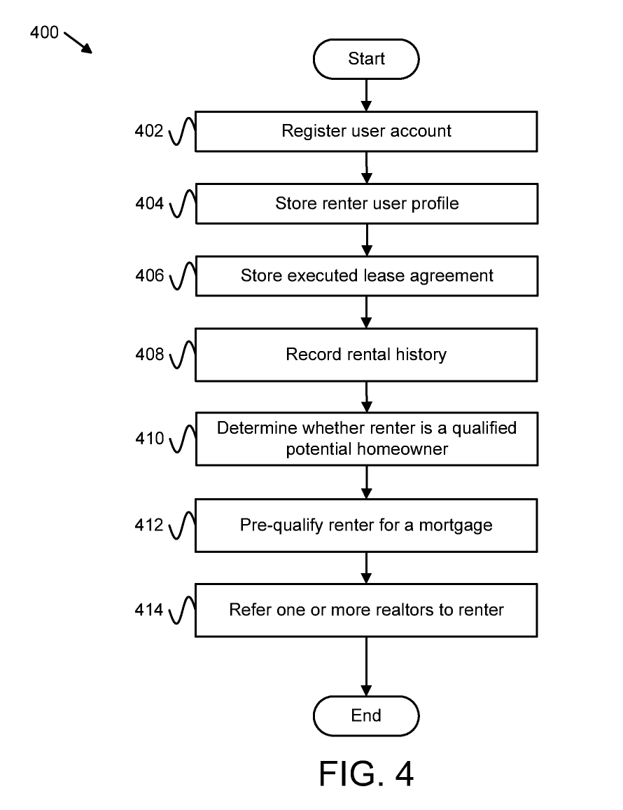

FIG. 4 is a schematic flow chart illustrating one embodiment of a method 400 for facilitating property rentals, purchases, and management. The method 400 begins and registers 402 a user account for a renter. The method 400 stores 404 a user profile for the renter. In one embodiment, the renter profile includes biographical information, government identification, credit background, rental history, rental rating, and home purchasing preferences for the renter. The method 400 stores 406 an executed lease agreement between the renter and a landlord. The method 400 records 408 a rental history of the renter pertaining to the executed lease agreement. In one embodiment, the rental history includes amount of rent paid, date of rental payment, and whether a payment was late. The method 400 determines 410 whether the renter is a qualified potential homeowner. In one embodiment, the method 400 determines 410 whether the renter is a qualified potential homeowner based upon the home purchasing preferences of the renter. In another embodiment, the method 400 determines 410 whether the renter is a qualified potential homeowner based upon the credit background, rental rating, and rental history of the renter. The method 400 pre-qualifies 412 the renter for a mortgage in response to determining that the renter is a qualified potential homeowner. In one embodiment, pre-qualifying 412 the renter for a mortgage means submitting the user profile of the renter to one or more mortgage lenders. In this embodiment, the method 400 prepares a loan application for the renter using the user profile of the renter. In other embodiments, pre-qualifying 412 the renter includes inviting the renter to apply for a mortgage. The method 400 refers 414 one or more realtors to the renter. In one embodiment, the method 400 refers 414 one or more realtors to the renter based upon the home purchasing preferences of the renter (e.g., home purchase location). In another embodiment, the method 400 refers 414 one or more realtors to the renter based upon the ratings of the one or more realtors. In certain embodiments, the method 400 refers 414 one or more realtors to the renter based upon marketing fees paid by the one or more realtors.

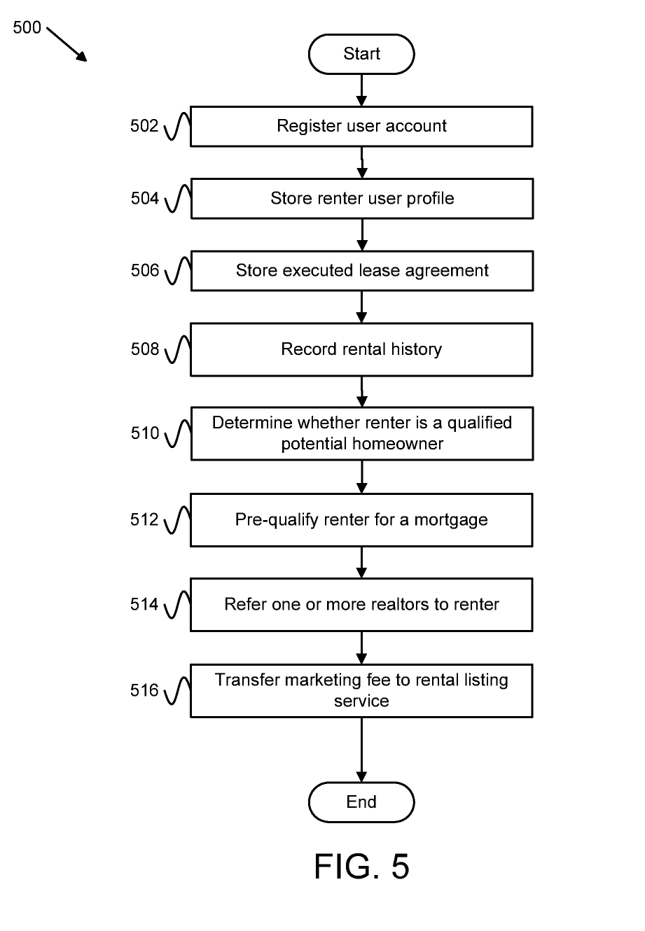

FIG. 5 is a schematic flow chart illustrating another embodiment of a method 500 for facilitating property rentals, purchases, and management. The method 500 begins and registers 502 a user account for a renter. The method 500 stores 504 a user profile for the renter. In one embodiment, the renter profile includes biographical information, government identification, credit background, rental history, rental rating, and home purchasing preferences for the renter. The method 500 stores 506 an executed lease agreement between the renter and a landlord. The method 500 records 508 a rental history of the renter pertaining to the executed lease agreement. In one embodiment, the rental history includes amount of rent paid, date of rental payment, and whether a payment was late. The method 500 determines 510 whether the renter is a qualified potential homeowner. In one embodiment, the method 500 determines 510 whether the renter is a qualified potential homeowner based upon the home purchasing preferences of the renter. In another embodiment, the method 500 determines 510 whether the renter is a qualified potential homeowner based upon the credit background, rental rating, and rental history of the renter. The method 500 pre-qualifies 512 the renter for a mortgage in response to determining that the renter is a qualified potential homeowner. In one embodiment, pre-qualifying 512 the renter for a mortgage means submitting the user profile of the renter to one or more mortgage lenders. In this embodiment, the method 500 prepares a loan application for the renter using the user profile of the renter. In other embodiments, pre-qualifying 512 the renter includes inviting the renter to apply for a mortgage. The method 500 refers 514 one or more realtors to the renter. In one embodiment, the method 500 refers 514 one or more realtors to the renter based upon the home purchasing preferences of the renter (e.g., home purchase location). In another embodiment, the method 500 refers 514 one or more realtors to the renter based upon the ratings of the one or more realtors. In certain embodiments, the method 500 refers 514 one or more realtors to the renter based upon marketing fees paid by the one or more realtors. The method 500 transfers 516 a marketing fee from one or more mortgage lenders and/or realtors to a rental listing service. In one embodiment, the marketing fee is based on the referral of a mortgage lender or realtor to a renter. In another embodiment, the marketing fee is based on the renter electing to use the services of the referred mortgage lender or realtor. In some embodiments, the marketing fee is based on both the referral of a mortgage lender or realtor and the renter's subsequent selection of the mortgage lender or realtor.

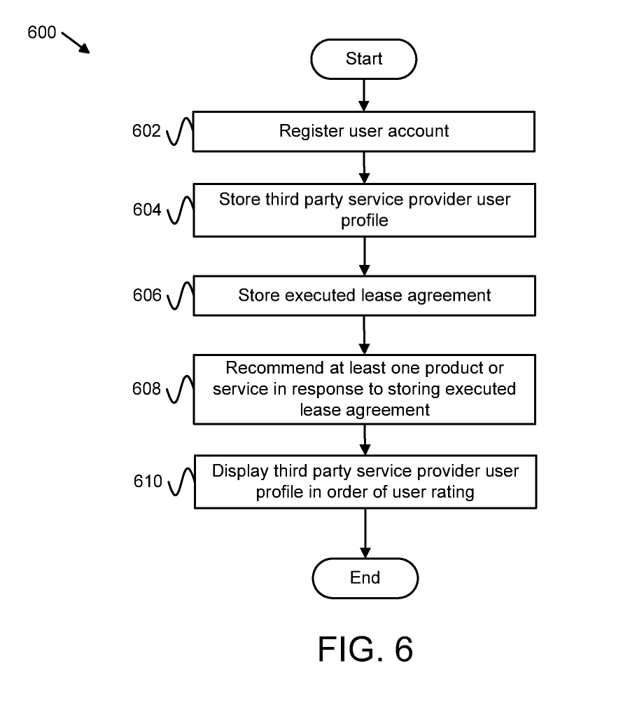

FIG. 6 is a schematic flow chart illustrating one embodiment of a method 600 for facilitating relocation and property management. The method 600 begins and registers 602 user accounts for a plurality of third party service providers that provide property maintenance and repair services. The method 600 stores 604 user profiles for the plurality of property maintenance and repair service providers. In one embodiment, each user profile includes biographical information, a description of at least one service offered by the third party service provider, at least one professional license, and an overall rating for the property maintenance and repair service provider. The method 600 stores 606 an executed lease agreement between a renter and a landlord. The method 600 recommends 608 at least one product or service to the renter in response to storing the executed lease agreement. In one embodiment, the at least one product or service recommendation is based upon the location of the rental property. In another embodiment, the at least one product or service recommendation is further based upon the current location of the renter. The method 600 displays 610 the user profiles of the property maintenance and service provider in the order of the overall rating for each property maintenance service provider. In one embodiment, the overall rating for a property maintenance and repair service provider includes individual ratings for the property maintenance and repair service provider and a count of individual ratings for the property maintenance and repair service provider.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to facilitate property rental, purchase, and management, the apparatus comprising:
a user profile module storing a user profile comprising biographical information, government issued identification, credit background, rental history, rental rating, and home purchasing preferences pertaining to a renter;
a property profile module monitoring a vacant rental property;
a notification module scheduling and sending alerts of one or more expected events to users;
a payment transaction module transferring payments between users; and
a renter evaluation module determining whether the renter is a qualified potential homeowner,
wherein at least a portion of the user profile module, the property profile module, the notification module, the renter evaluation module, the loan qualification module, and the realtor reference module comprise one or more of hardware and executable code, the executable code stored on one or more computer readable storage media.

2. The apparatus of claim 1, wherein determining whether the renter is a qualified potential homeowner comprises determining the home buying preference, home buy date, credit background, and rental history of the renter.

3. The apparatus of claim 1, further comprising a loan qualification module pre-qualifying the renter for a mortgage in response to determining that the renter is a qualified potential homeowner.

4. The apparatus of claim 3, wherein pre-qualifying the renter for a mortgage comprises submitting the user profile of the renter to a mortgage lender.

5. The apparatus of claim 4, further comprising a realtor reference module referring a realtor to the renter based upon the home purchasing preferences of the renter.

6. The apparatus of claim 5, wherein the payment transfer module transfers a referral fee from the mortgage lender and the realtor to a rental listing service in response to the realtor reference module referring the realtor to the renter and the loan qualification module submitting the user profile of the renter to the mortgage lender.

7. The apparatus of claim 1, wherein the property profile module further notifies a landlord of the vacant rental property in response to detecting a change in one or more conditions of the vacant rental property.

8. The apparatus of claim 7, wherein the property profile module further transmits commands from the landlord to control one or more features of the vacant rental property.

9. A method comprising:
storing a user profile comprising biographical information, government issued identification, credit background, rental history, rental rating, and home purchasing preferences pertaining to a renter;
monitoring a vacant rental property;
scheduling and sending alerts of one or more expected events to users;
transferring payments between users; and
determining whether the renter is a qualified potential homeowner.

10. The method of claim 9, wherein determining whether the renter is a qualified potential homeowner comprises determining the home buying preference, home buy date, credit background, and rental history of the renter.

11. The method of claim 9, further comprising pre-qualifying the renter for a mortgage in response to determining that the renter is a qualified potential homeowner.

12. The method of claim 11, wherein pre-qualifying the renter for a mortgage comprises submitting the user profile of the renter to a mortgage lender.

13. The method of claim 12, further comprising referring a realtor to the renter based upon the home purchasing preferences of the renter.

14. The method of claim 13, further comprising transferring a referral fee from the mortgage lender and the realtor to a rental listing service in response to referring the realtor to the renter and submitting the user profile of the renter to the mortgage lender.

15. The method of claim 9, further comprising notifying a landlord of the vacant rental property in response to detecting a change in one or more conditions of the vacant rental property.

16. The method of claim 10, further comprising transmitting commands from the landlord to control one or more features of the vacant rental property.

17. An apparatus to facilitate property rental, purchase, and management, the apparatus comprising:
a user profile module storing a user profile comprising biographical information, government issued identification, credit background, rental history, rental rating, and home purchasing preferences pertaining to a renter;
a leasing module storing an executed lease agreement in a user profile of the renter;
a relocation referral module recommending at least one product or service to the renter in response to storing the executed lease agreement; and
a maintenance coordination module displaying profiles of one or more property maintenance service providers in the order of an overall rating of each service provider;
wherein at least a portion of the user profile module, the leasing module, the relocation referral module, and the maintenance coordination module comprise one or more of hardware and executable code, the executable code stored on one or more computer readable storage media.

18. The apparatus of claim 15, wherein the at least one product or service recommendation is based upon the location of the rental property.

19. The apparatus of claim 16, wherein the at least one product or service recommendation is further based upon the current residence of the renter.

20. The apparatus of claim 15, wherein the overall rating of each property maintenance service provider comprises an average individual rating for the property maintenance service provider and a count of the individual ratings for the property maintenance service provider.
